(19) United States
(12) Patent Application Publication
(10) Pub. No.: US 2008/0163718 A1
(43) Pub. Date: Jul. 10, 2008

(54) Ergonomic Road Bicycle Handlebar

(76) Inventor: Cheng Hsun CHIANG, Ta-Li City (TW)

Correspondence Address: Dr. BANGER SHIA, 102 Lindencrest Ct., Sugar Land, TX, 77479-5201, US

(21) Appl. No.: 11/620,611

(22) Filed: Jan. 5, 2007

(51) Int. Cl. B62K 21/12

(52) U.S. Cl. 74/551.8

(57) ABSTRACT

An ergonomic road bicycle handlebar comprises a base, a brake control handle a gear shift handle, a cushion that covers a holding portion of the base and three spherical cushions. The brake control handle and the gear shift handle both of which are pivotally coupled to the holding portion are respectively covered with a spherical cushion. Moreover the cushion and the spherical cushions are all made of elastic material to improve the feeling of gripping and the using and to provide the buffer function for absorbing the shake caused during the riding process.

### BACKGROUND OF THE INVENTION

1. Field of the Invention

The present invention relates to a road bicycle, and more particularly to an ergonomic road bicycle handlebar.

2. Description of the Prior Art

Bicycles are generally divided into mountain bicycle (also called cross-country bicycle) and road bicycle (also called roadster or racing bicycle) according to function. Here we are going to discuss about the road bicycle only.

Referring to FIG. 1, a conventional handlebar comprises a brake control handle 12 and a gear shift handle 13 which are pivotally connected to a holding portion 11 of a base 10. During the riding process, the rider has to keep gripping firmly the handle all the time. When the rider holds the handle, the handle bears partial weight of the rider. Moreover the shake causing during the riding process will also be transmitted to the rider. So if the handle cannot effectively reduce the pressure from the rider's weight and absorb the shake caused during the riding process, the rider must feel uncomfortable.

The present invention has arisen to mitigate and/or obviate the afore-described disadvantages.

### SUMMARY OF THE INVENTION

The primary objective of the present invention is to provide an ergonomic road bicycle handlebar covered with a cushion to make the holding more comfortable.

The second objective of the present invention is to provide an ergonomic road bicycle handlebar utilizing two spherical cushions respectively mounted on a brake control handle and a gear shift handle to make the using more comfortable.

The ergonomic road bicycle handle in accordance with the preferred embodiment of the present invention, on the holding portion of which is covered with a cushion, and the cushion is made of elastic material so as to be griped by the rider. Two spherical cushions are respectively assembled on the gear shift handle and the brake control handle both of which are pivotally coupled to the holding potion, and the spherical cushions are also made of elastic material.

The cushion and the spherical cushions not only can reduce the pressure and absorb the shake, but also can improve the feeling of the using and the holding.

### BRIEF DESCRIPTION OF THE DRAWINGS

FIG. 1 is a perspective view of a conventional handlebar;

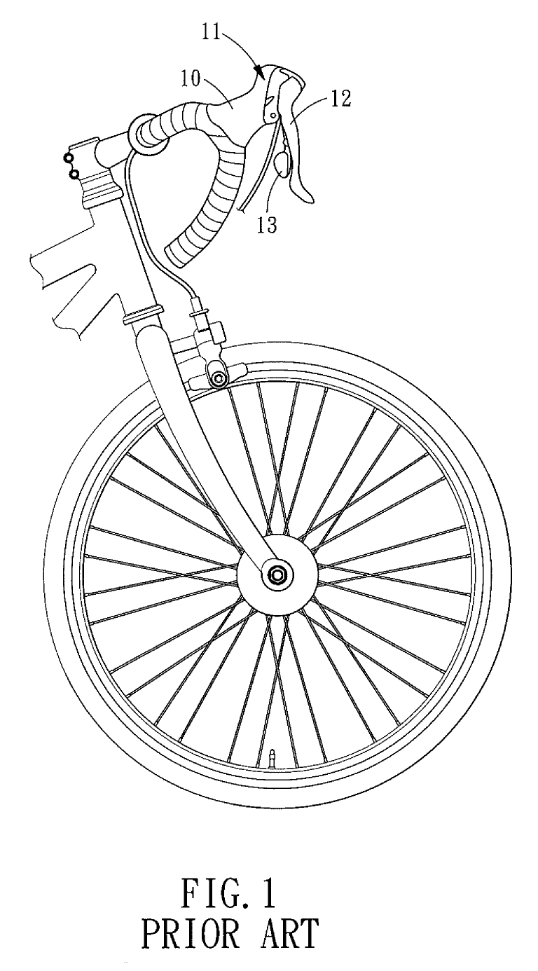

FIG. 2 is a perspective view of a handlebar in accordance with the preferred embodiment of the present invention;

FIG. 3 shows a handlebar of the preferred embodiment in accordance with the prevent invention is being held; and

FIG. 4 is a perspective view of a handlebar in accordance with the preferred embodiment of the present invention in pulling and pressing state.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

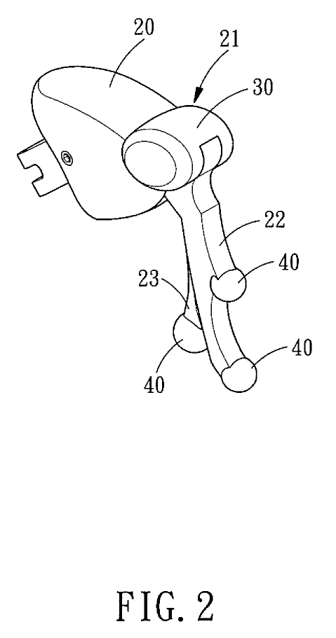

Referring to FIGS. 2-4, an ergonomic road bicycle handle in accordance with the preferred embodiment of the present invention is shown and comprises a base 20, a brake control handle 22, a gear shift handle 23, a cushion 30 and three cushions 40.

The base 20 has a holding portion 21.

The brake control handle 22 is pivotally coupled to the holding portion 21 of the base 20.

The gear shift handle 23 is pivotally coupled to the holding portion 21 of the base 20 and is located adjacent to the brake control handle 22.

The cushion 30, located correspondingly to the rotatable shaft of the brake control handle 22 and the gear shift handle 23, is made of elastic material and covers the holding portion 21. The side surface of the cushion 30 in this embodiment is made of plastic and its shape is elliptical, and the side surface of the cushion 30 is smaller than the normal palm.

The three spherical cushions 40 are made of elastic material, two of them are respectively assembled to the central portion of the brake control handle 22 and a far end of the brake control handle 22 opposite to the holding portion 21, another spherical cushion 40 is assembled on the far end of the gear shift handle opposite to the holding portion 21. The material of the spherical cushions of the preferred embodiment is plastic.

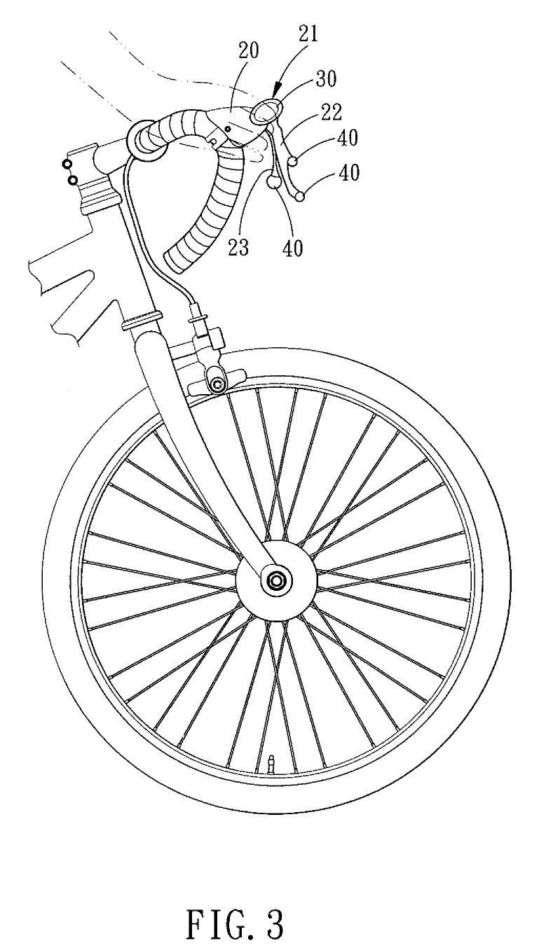

As shown in FIG. 3, when the rider holds the handlebar, the cushion 30 can be provided for gripping to support the body of the rider, since the cushion 30 is made of elastic material, the counterforce of the weight of the rider acted on the cushion 30 can be absorbed by the cushion 30 and can be reduced, and consequently the force applied to the rider when holding the handle can be reduced. In addition, when riding on the bumpy road, the shake will occur, the cushion 30 and the spherical cushions 40 can also absorb the shake transmitted to the hands of the rider to ease the uncomfortable feeling caused by the shake, therefore, the cushion 30 and the spherical cushions can make rider more comfortable when gripping.

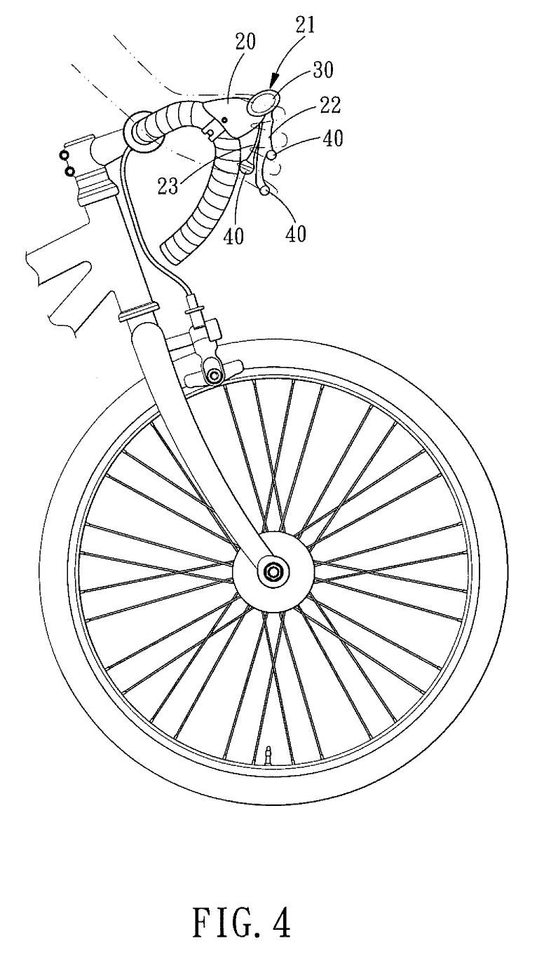

Referring to FIG. 4, the rider can pull the brake control handle 22 and the gear shift handle 23 by pulling the spherical cushions 40 with fingers, Since the spherical cushions are made of elastic material, which improves the feeling of gripping and prevents slippage.

To summarize, the present invention is an ergonomic road bicycle handlebar, on a holding portion of a base is covered with a cushion, and two spherical cushions respectively cover a brake control handle and a gear shift handle both of which are pivotally coupled to the holding portion. The cushion and the spherical cushions are all made of elastic material so as to improve the feeling of gripping and using and to provide buffer function for absorbing the shake caused during the riding process.

While we have shown and described various embodiments in accordance with the present invention, it is clear to those skilled in the art that further embodiments may be made without departing from the scope of the present invention.

What is claimed is:

1. An ergonomic road bicycle handlebar comprising: a brake control handle and a gear shift handle both of which are pivotally coupled to a holding portion of a base, characterized in that:
a cushion, located correspondingly to the rotatable shaft of the brake control handle and the gear shift handle, is made of elastic material and covers the holding portion, on the mid portion and a far end of the gear shift handle opposite to the holding portion is respectively assembled a spherical cushion, another elastic spherical cushion is assembled on a far end of the brake control handle opposite to the holding portion.

2. The ergonomic road bicycle handlebar as claimed in claim 1, wherein a side surface of the cushion is elliptical-shaped.

3. The ergonomic road bicycle handlebar as claimed in claim 1, wherein the cushion is made of plastic material.

4. The ergonomic road bicycle handlebar as claimed in claim 2, wherein the cushion is made of plastic material.

5. The ergonomic road bicycle handlebar as claimed in claim 1, wherein the material of the two spherical cushions is plastic.

6. The ergonomic road bicycle handlebar as claimed in claim 1, the material of the spherical cushion of the gear shift handle is plastic.

7. The ergonomic road bicycle handlebar as claimed in claim 1, the material of the spherical cushions is plastic.

8. The ergonomic road bicycle handlebar as claimed in claim 1 the material of the side surface of the cushion, the cushion and the spherical cushions all is plastic.
